(19) United States
(12) Patent Application Publication
(10) Pub. No.: US 2023/0035876 A1
(43) Pub. Date: Feb. 2, 2023

(54) METHOD, APPARATUS, AND STORAGE MEDIUM FOR DIVIDING NEURAL NETWORK

(71) Applicant: HON HAI PRECISION INDUSTRY CO., LTD., New Taipei (TW)

(72) Inventor: CHIEN-WU YEN, New Taipei (TW)

(21) Appl. No.: 17/740,969

(22) Filed: May 10, 2022

(30) Foreign Application Priority Data
Jul. 27, 2021 (CN) 202110853104.7

(51) Int. Cl. G06N 3/063; H04L 41/0893; H04L 41/0631

(52) U.S. Cl. CPC G06N 3/063; H04L 41/0893; H04L 41/065

(57) ABSTRACT

A method, an apparatus, and a storage medium for dividing a neural network into regions for preventing data duplication and data loss in parallel movements of data between nodes. The method includes obtaining a neural network model comprising n operators; scanning all operator groups in the neural network model; dividing the neural network model into m regions; rescanning all operator groups in the neural network model and identifying broken operator group(s); analyzing input and output of each of the n number of operators in the broken operator group(s) and identifies operators of a specific sort; and adjusting the operators of the specific type to rearranged to keep individual inputs and outputs within a single region.

### FIELD

The subject matter herein generally relates to telecommunications technology, specifically a method, an apparatus, and a storage medium for dividing neural network.

### BACKGROUND

Apparatuses need to process input from the real world, such as industrial robots, autonomous vehicles, and mobile communication devices. Tasks processed by the apparatus mostly are machine learning, operations thereof mostly are vector operations or matrix operations, which have high degree of parallelism. In normal neural network algorithms, neural network models may be divided into a plurality of collateral regions. However, among the plurality of regions, a single path may lead to two or more regions, or may lead to an earlier but currently non-functional region. Data may be lost in either of these situations.

### BRIEF DESCRIPTION OF THE DRAWINGS

In order to more clearly describe the technical solutions in the embodiments of the present disclosure or the prior art, the following will briefly introduce the drawings that need to be used in the description of the embodiments or the prior art. Obviously, the drawings in the following description are only examples. For those of ordinary skill in the art, other drawings can be obtained according to the provided drawings without creative work.

FIG. 1 is a flowchart of a method for dividing a neural network provided in one embodiment of the present disclosure.

FIG. 2 shows a neural network model in one embodiment of the present disclosure.

FIG. 3 shows the neural network model of FIG. 2 being divided into regions in one embodiment of the present disclosure.

FIG. 4 is a block diagram of an apparatus implementing the method in one embodiment of the present disclosure.

### DETAILED DESCRIPTION

For clarity, of illustration of objectives, features and advantages of the present disclosure, the drawings combined with the detailed description illustrate the embodiments of the present disclosure hereinafter. It is noted that embodiments of the present disclosure and features of the embodiments can be combined, when there is no conflict.

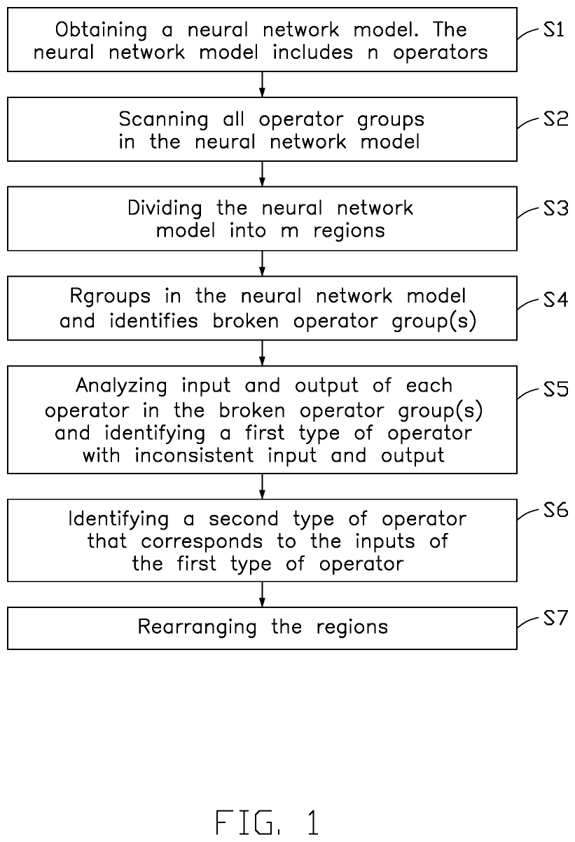

FIG. 1 is a flowchart of a method for dividing neural network in one embodiment. According to different requirements, the order of the blocks in the flowchart may be changed, and some blocks may be omitted.

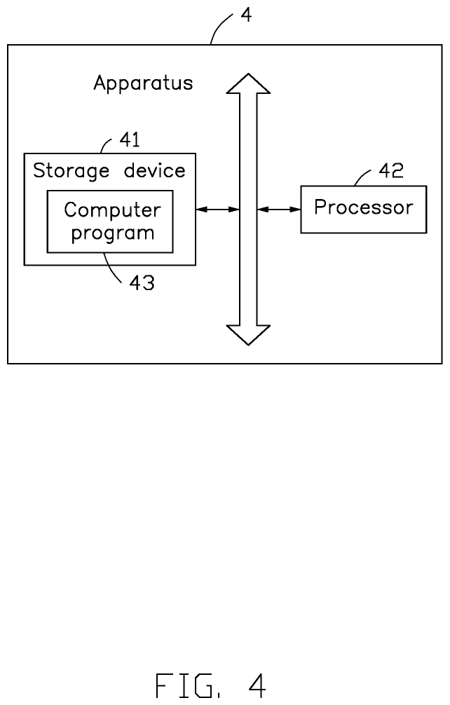

The method may be executed by an apparatus (e.g., apparatus 4 in FIG. 4). The apparatus may be a device that can perform processing according to preset or stored instructions, such as a desktop computer, a notebook, a palmtop computer, or a cloud server. Hardware of the apparatus may include, but is not limited to, a microprocessor, an disclosure specific integrated circuit (ASIC), a field-programmable gate array (FPGA), a digital signal processor (DSP), an embedded device, etc.

The apparatus can be any electronic product that can interact with a user, such as a personal computer, a tablet computer, a smart phone, a personal digital assistant (PDA), a game console, an Internet protocol television (IPTV), a smart wearable device, etc.

The apparatus may also be a network device and/or user equipment. The network device includes, but is not limited to, a single network server, a server group formed by multiple network servers, or a cloud formed by a large number of hosts or network servers based on cloud computing.

The apparatus can be included in a network. The network can be, but is not limited to, the Internet, a wide area network, a metropolitan area network, a local area network, a virtual private network (VPN), and the like.

In block S1, the apparatus obtains a neural network model. The neural network model includes n operators.

The neural network model may be obtained from a network. The neural network model may be optimized after obtaining from the network. Optimization of the neural network model can include operations such as operator fusion, network pruning, model quantization, and network cutting on the neural network model.

In the embodiment, the neural network model includes n operators, these are denoted as Op1, Op2, . . . , Opn. Each of the operators includes one or more input and one or more output. For adjacent operators, an output of an earlier operator may become an input to a later operator. An output of an operator may be input(s) for one or more operators, and an input of an operator may be from the output(s) of one or more operators.

In block S2, the apparatus scans all operator groups in the neural network model.

In one embodiment, the neural network model includes a plurality of operator groups, each of the operator groups includes a plurality of connected operators. In one embodiment, the apparatus may scan all operator groups in the neural network model by algorithms such as Directed Acyclic Graph (DAG), Depth First Search (DFS), and/or Breadth First Search (BFS).

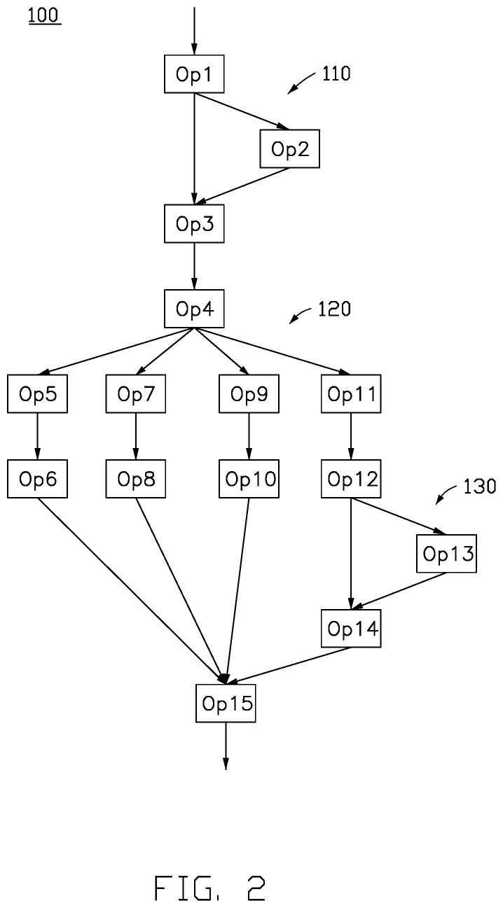

In one embodiment, FIG. 2 shows a neural network model 100 including 15 operators, the operators can be respectively denoted as Op1, Op2, . . . , Op15. By scanning the neural network model 100, there are three operator groups, which can be a first operator group 110, a second operator group 120, and a third operator group 130.

In one embodiment, each of the operator groups can be respectively denoted as Lx(f, e), wherein Lx is a series, f is an initial operator of the operator group, e is a terminal operator of the operator group. In this way, the three operator groups of the neural network model 100 can be respectively denoted as L1(Op1, Op3), L1(Op4, Op15), L2(Op12, Op14).

In block S3, the apparatus divides the neural network model into m regions.

In one embodiment, the apparatus divides the plurality of operators in the neural network model into m regions, wherein m is an integer of two or more than two. Each of the regions includes substantially the same number of operators.

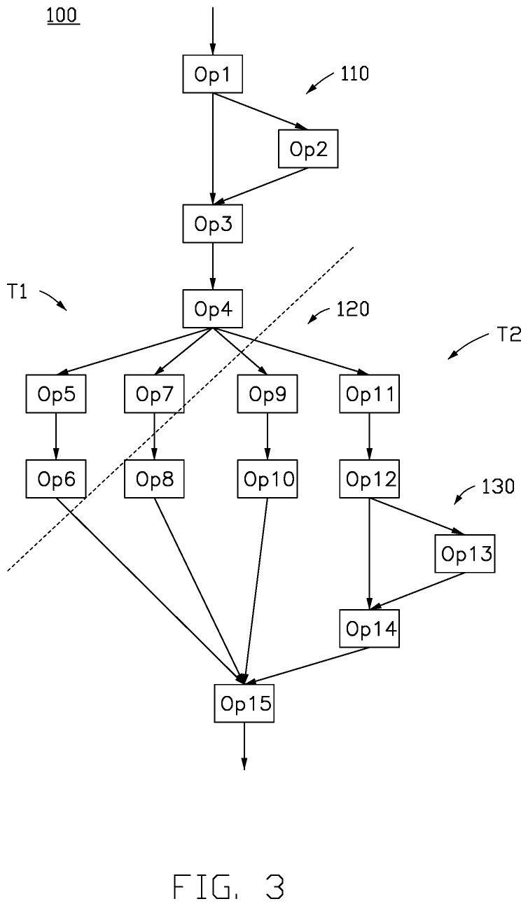

In one embodiment, FIG. 3 shows the neural network model 100 divided into two regions, which are a first region T1 and a second region T2. Operators Op1, Op2, . . . , Op7 are in the first region T1, operators Op8, Op9, . . . , Op15 are in the second region T2. Therefore, the first region T1 and the second region T2 include substantially the same number of operators.

In block S4, the apparatus rescans all operator groups in the neural network model and identifies broken operator group(s).

In one embodiment, the apparatus rescans all operator groups in the neural network model to identify whether there is an operator group which is positioned in more than one region. That is, some operators of one of the operator groups is in one region, and remaining operators of the operator group are in another region. In one embodiment, the neural network model may be simultaneously executed by a plurality of processors.

In one embodiment, FIG. 3 shows the three operator groups of the neural network model 100, the first operator group 110 is positioned in the first region T1, that is operators Op1, Op2, and Op3 are in the first region T1; the third operator group 130 is positioned in the second region T2, that is operators Op12, Op13, and Op14 are in the second region T2. The second operator group 120 is thus split between the first region T1 and the second region T2, that is, some operators, such as Op4, Op5, . . . , are in the first region T1, and some operators, such as Op9, Op10, . . . , are in the second region T2. Thus, the second operator group 120 is identified as a broken operator group.

In one embodiment, when the neural network model 100 is simultaneously executed by two processors, the first region T1 and the second region T2 may be controlled by one processor. In addition, each of the processors controls its regions by providing them with an equal time duration, so as to decrease a waiting time and improve a load balancing.

In block S5, the apparatus analyzes input and output of each operator in the broken operator group(s) and identifies a first type of operator with inconsistent input and output.

In one embodiment, the apparatus analyzes input and output of each operator in the broken operator group(s) and identifies operators whose input and output are in different regions. That is, when an input of an operator in the broken operator group(s) is in one region, an output of the operator is in another region, the operator is identified as the first type of operator, a cross-region operator.

In one embodiment, FIG. 3 shows the second operator group 120 of the neural network model 100 is identified as the broken operator group, the apparatus analyzes input and output of each operator Op4, Op6, . . . . In detail, an output of the operator Op4 is in the first region T1; an output of the operator Op6 is in the first region T1; an output of the operator Op7 is in the first region T1; an input of the operator Op8 is in the first region T1 and an output of the operator Op8 is in the second region T2; an input of the operator Op9 is in the first region T1 and an output of the operator Op9 is in the second region T2; an input of the operator Op11 is in the first region T1 and an output of the operator Op11 is in the second region T2; an input of the operator Op15 is in the first region T1 and an output of the operator Op15 is in the second region T2. Other operators with input and output being in one region only are not described here. Therefore, each of the operators Op8, Op9, Op11, and Op15 has input and output being in different regions, which are cross-region operators. That is, the input of each of the operators Op8, Op9, Op11, Op15 is from another region. Thus, operators Op8, Op9, Op11, and Op15 are identified as the first type of operator.

In block S6, the apparatus identifies a second type of operator that corresponds to the inputs of the first type of operator.

In one embodiment, the apparatus analyzes operators which correspond to the inputs of the operators in the first sort of operator, and identifies these operators as the second type of operator.

In one embodiment, FIG. 3 shows the first type of operator, an input of operator Op8 is from an output of operator Op7; inputs of operator Op9, Op11 are from an output of operator Op4; an input of operator Op15 is from an output of operator Op6. Therefore, the apparatus identifies the operators Op4, Op6, Op7 as the second type of operator.

In block S7, the apparatus rearranges the regions.

In one embodiment, the apparatus adjusts outputs of the second type of operator to the region that the outputs of the first type of operator positioned in, so as to rearrange the regions.

In one embodiment, FIG. 3 shows the neural network model 100, the apparatus adjusts outputs of the second type of operator Op4, Op6, and Op7 to the region that the outputs of the first type of operator Op8, Op9, Op11, Op15 positioned in, that is the second region T2, so as to rearrange the first region T1 and the second region T2.

Thus, data transmission or data merge of the operators in a same path of the rearranged two regions may better match and improve data safety.

FIG. 1 describes in detail the method for dividing neural network of the present disclosure. Hardware architecture that implements the method for dividing neural network is described in conjunction with FIG. 4.

FIG. 4 is a block diagram of an apparatus implementing the method in one embodiment of the present disclosure. The apparatus 4 may include a storage device 41 and at least one processor 42. A computer program 43 (such as an image detection system) may be stored in the storage device 41 and executable by the processor 42. The processor 42 may execute the computer program to implement the blocks in the method for dividing neural network described above, such as the blocks S1 to S7 in FIG. 1.

The apparatus 4 may be a device that can perform processing according to preset or stored instructions, such as a desktop computer, a notebook, a palmtop computer, or a cloud server. Hardware of the apparatus may include, but is not limited to, a microprocessor, an application-specific integrated circuit (ASIC), a field-programmable gate array (FPGA), a digital signal processor (DSP), an embedded device, etc.

Those skilled in the art will understand that apparatus 4 is only an example, and does not constitute a limitation. Other examples of apparatus 4 may include more or fewer components than shown in FIG. 4, or combine some components, or have different components.

The storage device 41 may be used to store the computer program, and the processor 42 implements the apparatus by running or executing the computer program or module stored in the storage device 41 and calling up data stored in the storage device 41. The storage device 41 may include a storage program area and a storage data area. The storage program area may store an operating system, and programs required by at least one function, etc.; the storage data area may store data and the like created in the use of the apparatus 4. In addition, the storage device 41 may include non-volatile memory, such as a hard disk, a memory, a plug-in hard disk, a smart memory card (SMC), a secure digital (SD) card, a flash memory card (Flash Card), at least one magnetic disk storage device, flash memory device, or other non-volatile solid state storage device.

The processor 42 may be a central processing unit (CPU) or other general-purpose processor, a digital signal processor (DSP), an application-specific integrated circuit (ASIC), a field-programmable gate array (FPGA) or other programmable logic device, a discrete gate, or a transistor logic device, or a discrete hardware component, etc. The processor 42 may be a microprocessor or any conventional processor. The processor 42 may be a control center of the apparatus 4, and connect various parts of the entire apparatus 4 by using various interfaces and lines.

In an exemplary embodiment, the computer program may be divided into one or more modules, and the one or more modules are stored in the storage device 41 and executed by the processor 42 to complete the method for dividing neural network of the present disclosure. The one or more modules can be a series of computer-readable instruction segments capable of performing specific functions, and the instruction segments are used to describe execution processes of the computer program in the apparatus 4.

When the modules integrated in the apparatus 4 are implemented in the form of software functional units and used as independent units, they can be stored in a non-transitory readable storage medium. According to this understanding, all or part of the processes in the methods of the above embodiments implemented by the present disclosure can also be completed by related hardware instructed by computer-readable instructions. The computer-readable instructions may be stored in a non-transitory readable storage medium. The computer-readable instructions, when executed by the processor, may implement the blocks of the foregoing method embodiments. The computer-readable instructions include computer-readable instruction codes, and the computer-readable instruction codes can be source code, object code, an executable file, or in some other intermediate form. The non-transitory readable storage medium may include any entity or device capable of carrying the computer-readable instruction code, a recording medium, a U disk, a mobile hard disk, a magnetic disk, an optical disk, a computer memory, and a read-only memory (ROM).

Although not shown, the apparatus 4 may also include a power source (such as a battery) for supplying power to various components. The power source may be logically connected to the at least one processor 42 through a power management device, so as to realize functions such as charging, discharging, and power consumption management. The power supply may also include direct current or alternating current power supplies, recharging devices, power failure detection circuits, power converters or inverters, and power status indicators. The apparatus 4 may also include various sensors, BLUETOOTH modules, WI-FI modules, etc.

In several embodiments provided in the preset disclosure, it should be understood that the disclosed apparatus and method may be implemented in other ways. For example, the embodiments of the apparatus described above are merely illustrative. For example, the units are only divided according to logical function, and there may be other manners of division in actual implementation.

The modules described as separate components may or may not be physically separated, and the components displayed as modules may or may not be physical modules, that is, may be located in one place, or may be distributed on multiple network elements. Some or all of the modules may be selected according to actual needs to achieve the purpose of the solution of this embodiment.

In addition, each functional unit in each embodiment of the present disclosure can be integrated into one processing unit, or can be physically present separately in each unit, or two or more units can be integrated into one unit. The above integrated unit can be implemented in a form of hardware or in a form of a software functional unit.

The above integrated modules implemented in the form of function modules may be stored in a storage medium. The above function modules may be stored in a storage medium, and include several instructions to enable an apparatus (which may be a personal computer, server, or network device, etc.) or processor to execute the method described in the embodiment of the present disclosure.

The present disclosure is not limited to the details of the above-described exemplary embodiments, and the present disclosure can be embodied in other specific forms without departing from the spirit or essential characteristics of the present disclosure. Therefore, the present embodiments are to be considered as illustrative and not restrictive, and the scope of the present disclosure is defined by the appended claims. All changes and variations in the meaning and scope of equivalent elements are included in the present disclosure. Any reference sign in the claims should not be construed as limiting the claim. Furthermore, the word “comprising” does not exclude other units nor does the singular exclude the plural. A plurality of units or devices stated in the system claims may also be implemented by one unit or device through software or hardware. Words such as “first” and “second” are used to indicate names but not to signify any particular order.

Finally, the above embodiments are only used to illustrate technical solutions of the present disclosure, and are not to be taken as restrictions on the technical solutions. Although the present disclosure has been described in detail with reference to the above embodiments, those skilled in the art should understand that the technical solutions described in one embodiments can be modified, or some of technical features can be equivalently substituted, and that these modifications or substitutions are not to detract from the essence of the technical solutions or from the scope of the technical solutions of the embodiments of the present disclosure.

We claim:

1. A method of dividing neural network applied in an apparatus, the method comprising:
obtaining a neural network model comprising n number of operators;
scanning every operator groups in the neural network model;
dividing the neural network model into m number of regions;
rescanning every operator groups in the neural network model and identifying broken operator group(s);
analyzing input and output of each of the n number of operators in the broken operator group(s) and identifies operators of a specific type; and
adjusting the operators of the specific type to rearrange the m number of regions.

2. The method of claim 1, wherein the analyzing input and output of each of the n number of operators in the broken operator group(s) and identifies operators of a specific type comprises:
identifying operators of a first type that with inconsistent input and inconsistent output;
identifying operators of a second type that corresponding to inputs of the operators of the first type.

3. The method of claim 2, wherein the identifying operators of the first type that with inconsistent input and inconsistent output comprises:
analyzing input and output of each operator in the broken operator group(s); and
identifying operators whose input and output being in different regions as the first type.

4. The method of claim 3, wherein the identifying operators of the second type that corresponding to inputs of the operators of the first type comprises:
identifying operators corresponding to the inputs of the operators of the first type as the second type.

5. The method of claim 4, wherein the adjusting the operators of the specific type to rearrange the m number of regions comprises:
adjusting outputs of the operators of the second type to a region that the outputs of the operators of the first type positioned in.

6. The method of claim 1, wherein each of the n number of operators comprises one or more input and one or more output; for adjacent operators, an output of an earlier operator is an input of a later operator; an output of an operator is input(s) for one or more operators, an input of an operator is from output(s) of one or more operators.

7. The method of claim 1, wherein the scanning every operator group in the neural network model comprises:
dividing the n number of operators of the neural network model into the m number of regions, m is an integer of two or more than two, wherein each of the regions comprises a substantial same quantity of the operators.

8. The method of claim 1, wherein the rescanning every operator group in the neural network model and identifying broken operator group(s) comprises:
rescanning every operator group in the neural network model to identify whether the operator group that is positioned in more than one region.

9. An apparatus comprising:
at least one processor; and
a storage device storing computer-readable instructions, which when executed by the at least one processor, cause the at least one processor to:
obtain a neural network model comprising n operators;
scan all operator groups in the neural network model;
divide the neural network model into m regions;
rescan all operator groups in the neural network model and identifying broken operator group(s);
analyze input and output of each of the n number of operators in the broken operator group(s) and identifies operators of a specific type; and
adjust the operators of the specific type to rearrange the m number of regions.

10. The apparatus of claim 9, wherein the analyze input and output of each of the n number of operators in the broken operator group(s) and identifies operators of a specific type comprises:
identifying operators of a first type that with inconsistent input and inconsistent output;
identifying operators of a second type that corresponding to inputs of the operators of the first type.

11. The apparatus of claim 10, wherein the identify operators of the first type that with inconsistent input and inconsistent output comprises:
analyzing input and output of each operator in the broken operator group(s); and
identifying operators whose input and output being in different regions as the first type.

12. The apparatus of claim 11, wherein the identify operators of the second type that corresponding to inputs of the operators of the first type comprises:
identifying operators corresponding to the inputs of the operators of the first type as the second type.

13. The apparatus of claim 12, wherein the adjust the operators of the specific type to rearrange the m number of regions comprises:
adjusting outputs of the operators of the second type to a region that the outputs of the operators of the first type positioned in.

14. The apparatus of claim 9, wherein each of the n number of operators comprises one or more input and one or more output; for adjacent operators, an output of an earlier operator is an input of a later operator; an output of an operator is input(s) for one or more operators, an input of an operator is from output(s) of one or more operators.

15. The apparatus of claim 9, wherein the scan every operator group in the neural network model comprises:
Dividing the n number of operators of the neural network model into the m number of regions, m is an integer of two or more than two, wherein each of the regions comprises substantial same quantity of the operators.

16. The apparatus of claim 9, wherein the rescan every operator group in the neural network model and identifying broken operator group(s) comprises:
rescanning every operator group in the neural network model to identify whether the operator group that is positioned in more than one region.

17. A non-transitory storage medium having stored thereon computer-readable instructions that, when the computer-readable instructions are executed by a processor to implement the following method:
obtaining a neural network model comprising n operators;
scanning all operator groups in the neural network model;
dividing the neural network model into m regions;
rescanning all operator groups in the neural network model and identifying broken operator group(s);
analyzing input and output of each of the n number of operators in the broken operator group(s) and identifies operators of a specific type; and
adjusting the operators of the specific type to rearrange the m number of regions.

18. The non-transitory storage medium of claim 17, wherein the analyzing input and output of each of the n number of operators in the broken operator group(s) and identifies operators of a specific type comprises:
identifying operators of a first type that with inconsistent input and inconsistent output;
identifying operators of a second type that corresponding to inputs of the operators of the first type.

19. The non-transitory storage medium of claim 18, wherein the identifying operators of the first type that with inconsistent input and inconsistent output comprises:
analyzing input and output of each operator in the broken operator group(s); and
identifying operators whose input and output being in different regions as the first type.

20. The non-transitory storage medium of claim 19, wherein the identifying operators of the second type that corresponding to inputs of the operators of the first type comprises:
identifying operators corresponding to the inputs of the operators of the first type as the second type.
